(19) United States
(12) Patent Application Publication
(10) Pub. No.: US 2010/0154309 A1
(43) Pub. Date: Jun. 24, 2010

(54) Door opening and closing structure and door opening and closing system

(75) Inventors: Minoru Shibata, Aichi-ken (JP); Shinji Kumazawa, Aichi-ken (JP); Naoki Omatsu, Aichi-ken (JP); Toshiyasu Sayama, Aichi-ken (JP)

Correspondence Address: POSZ LAW GROUP, PLC, 12040 SOUTH LAKES DRIVE, SUITE 101, RESTON, VA, 20191, US

(73) Assignee: TOYODA GOSEI CO., LTD., Aichi-ken (JP)

(21) Appl. No.: 12/654,227

(22) Filed: Dec. 15, 2009

(30) Foreign Application Priority Data
Dec. 24, 2008 (JP) 2008-328826

(51) Int. Cl. E05F 11/24; E05F 11/02

(52) U.S. Cl. 49/338; 49/333

(57) ABSTRACT

Doors are made to open and close from a center of an opening of an accommodation box in such a manner as a double-leafed hinged door does via an interlocking mechanism (link mechanisms) which converts a sliding movement in a direction which is substantially normal to a plane including an opening into rotational movements of the doors around corresponding rotational axes which are set individually on left- and right-hand sides of the opening, and when they are in an open position where the opening is opened completely, the doors are stored compact to lie along left and right lateral sides of the accommodation box.

### BACKGROUND OF THE INVENTION

1. Field of the Invention

The present invention relates to a door opening and closing structure and a door opening and closing system and more particularly to a door opening and closing structure and a door opening and closing system which are adapted to be installed in an instrument panel of a vehicle or the like.

2. Related Art

A door opening and closing system having an accommodation box for accommodating small articles is provided in an instrument panel or a center console of a vehicle such as a four-wheeled motor vehicle.

As a door opening and closing system of this type, there has been known a door opening and closing system which is provided in a central portion of an instrument panel and which adopts a door opening and closing structure in which a single door is caused to rotate in a reciprocating fashion between a closed position where the door takes a substantially vertical posture to close an opening made to open on a front side of an accommodation box (accommodation space) to a fully closed extent and an open position which is set at an upper portion in the accommodation box and where the door takes a substantially horizontal posture to open the opening to a fully opened extent (for example, refer to JP-A-2008-254583).

According to this door opening and closing system, by operating a lock button or the like provided in a predetermined location on the door, the door is made to rotate upwards from the closed position towards the open position, thereby realizing an increase in both operability and design properties.

According to the door opening and closing structure, however, a space needs to be ensured at the upper portion in the accommodation box which corresponds to a rotating locus of the door (a door storing space) and further, clearance (clear space) that is to be provided for another member, which disturbs an increase in accommodation capacity of the accommodation box. Namely, it becomes difficult in design to ensure a sufficient accommodation capacity compared with the area of the opening of the accommodation box. This design-related difficulty will be produced similarly in a case where the closed position of the door is set at a lower portion of the accommodation box in the door opening and closing structure.

Further, in the case where the open position of the door is set at the upper portion of the accommodation box, the portion which is to be pinched by the finger tips to be pulled out manually takes the form of a pent roof, which interrupts an obliquely downward line of sight of a driver who is seated on a driver's seat, thereby deteriorating the visibility of an interior (accommodation space) of the accommodation box.

### SUMMARY OF THE INVENTION

The invention has been made with a view to solving the problem described above, and an object thereof is to provide a door opening and closing structure and a door opening and closing system which can provide good visibility of an interior of an accommodation space and ensure a sufficient accommodation capacity thereof.

With a view to solving the problem, the gist of a first aspect of the invention resides in a door opening and closing structure having a pair of rotational axes set on left and right sides of an opening through which an article is put in or out and a pair of left and right doors which are capable of rotating individually on the rotational axes so as to open and close, wherein

the doors opens and closes via an interlocking mechanism for converting a linear reciprocating motion which is substantially normal to a plane including the opening into a rotational reciprocating motion on each of the rotational axes and are stored to lie individually along left and right lateral sides of an accommodation space having the opening when the doors are in open positions where the opening is opened to a full extent.

According to the configuration described above, since the pair of left and right doors are caused to open and close together in such a way as the double-leafed hinged door does relative to the opening, the accommodation space having the opening can be expanded in a vertical (length or height) direction. By this, the capacity (accommodation capacity) of the accommodation space can be ensured largely compared with the area of the opening. Further, since the respective doors are made to be stored to lie individually along the left and right lateral sides of the accommodation space when the doors are in their open positions where the opening is opened to its full extent, the accommodation space can be expanded in a horizontal (width) direction, and when the door opening and closing structure is disposed at a central portion of an instrument panel, it becomes possible to increase the visibility of an interior of the accommodation space when the interior of the accommodation space is viewed from an obliquely upward position such as the position of the eyes of the driver who is seated in the driver's seat. Further, according to the interlocking mechanism for converting the linear reciprocating motion into the rotational reciprocating motion, in carrying out the conversion of the motions, the interlocking mechanism can be made to operate such that a rotational angular velocity of the rotational motion becomes gradually smaller as a traveling distance of the linear motion becomes longer.

The gist of a second aspect of the invention resides in a door opening and closing structure as set forth in the first aspect of the invention, wherein the interlocking mechanism includes a biasing device for imparting a biasing force to the doors in a direction in which the opening is opened or closed.

According to the configuration described above, since both the doors are caused to open and close by the interlocking mechanism for converting the linear reciprocating motion into the rotational reciprocating motion and the biasing device for imparting the biasing force to both the doors in the opening or closing direction via the interlocking mechanism, automatic opening and closing operations of both the doors can be realized by the structure which is inexpensive and easy to be adjusted without requiring an electric actuator as a drive source and a complex speed reduction mechanism.

The gist of a third aspect of the invention resides in a door opening and closing structure as set forth in the second aspect of the invention, wherein the interlocking mechanism comprises a pair of link mechanisms which are provided independently on the left and right sides of the opening to correspond to the rotational axes individually, and the biasing device is made to impart a biasing force simultaneously to the link mechanisms in one of linear directions in which linear reciprocating motions take place.

According to the configuration described above, since the interlocking mechanism for converting the linear reciprocating motion into the rotational reciprocating motion includes the link mechanisms and the biasing force of the biasing device is imparted to in the linear direction in which the link mechanism moves linearly, as the biasing device, the means can be adopted which is constructed so simply as to have only the function to bias the link mechanisms in the linear direction in which the link mechanism moves linearly. In addition, since both the link mechanisms are provided independently left and right to correspond individually to the rotational axes and the biasing device is made to impart the biasing force simultaneously to both the link mechanisms in the one of the linear directions in which the linear reciprocating motions take place, synchronized rotational reciprocating motions of both the doors can be realized easily and in an ensured fashion by both the link mechanisms.

The gist of a fourth aspect of the invention resides in a door opening and closing structure as set forth in the third aspect of the invention, wherein the link mechanisms each comprise a crank member which is provided integrally with the door such that a rotational center thereof coincides with the rotational axis of the door, a slider member adapted to move linearly in a direction which is substantially normal to the plane including the opening, and an arm member which is pivotally attached to the crank member at a first end portion and is pivotally attached to the slider member at a second end portion thereof, and wherein

the biasing device is an elastic member which is installed to be fixed to the accommodation box having the opening at one end and to be fixed to the slider member at the other end thereof so as to generate a biasing force which biases the slider member in a direction in which the slider member moves towards or away from the opening.

According to the configuration described above, mounting of both the doors for synchronized opening and closing and setting (adjusting) of such synchronized opening and closing conditions of both the doors can be implemented simply and in an ensured fashion by the pair of left and right link mechanisms each including the crank member which is provided integrally with the door, the slider member adapted to move linearly in the direction which is substantially normal to the plane including the opening, and the arm member which is pivotally attached to the crank member at the first end portion and is pivotally attached to the slider member at the second end portion thereof without plays and looseness (backlash) between gears which would be generated should a gear meshing mechanism be used.

The gist of a fifth aspect of the invention resides in a door opening and closing structure as set forth in any of the first to fourth aspects of the invention which includes a damper device for damping a linear reciprocating motion of the interlocking mechanism.

According to the configuration described above, since the linear reciprocating motion of the interlocking mechanism is made to be damped by the damper device, the feeling of stable and high-quality rotating operation can be imparted to the doors.

The gist of a sixth aspect of the invention resides in a door opening and closing structure as set forth in any of the first to fifth aspects of the invention which comprises further a lock device for holding both the doors in a closed position where the opening is closed completely or the open position where the opening is opened to its full extent when locked and releasing the holding of the doors when unlocked.

According to the configuration described above, both the doors can be fixed temporarily in the closed position or the open position simply and in an ensured fashion by the lock device for holding both the doors in the closed position where the opening is closed completely or the open position where the opening is opened to its full extent when locked and releasing the holding of the doors when unlocked.

The gist of a seventh aspect of the invention resides in a door opening and closing structure as set forth in any of the first to sixth aspects of the invention, wherein the interlocking mechanism is disposed in a flat plate-like shape on the accommodation box having the opening.

According to the configuration described above, since the interlocking mechanism is disposed in the flat plate-like shape on the accommodation box having the opening, the accommodation space of the accommodation box can be expanded further in the vertical direction.

The gist of an eighth aspect of the invention resides in a door opening and closing system including the door opening and closing structure set forth in any of the first to seventh aspects of the invention and adapted to be installed in a central portion of an instrument panel of a vehicle, wherein each of the rotational axes is set to be inclined so largely as to form a wider space between a surface of the corresponding door and itself as the rotational axis extends upwards.

According to the configuration described above, since each of the rotational axes is set to be inclined so largely as to form the wider space between the surface of the corresponding door and itself as the rotational axis extends upwards, when having arrived in the open position, both the doors are disposed to lie along the left and right lateral sides of the accommodation space to gradually narrow their width or a distance therebetween as they extend downwards, which provides a configuration suited to a design required for the central portion of the instrument panel. In addition, by this configuration, advantages are provided effectively that the accommodation space is expanded and that the visibility of an interior of the accommodation space is increased which results when the interior of the accommodation space is observed from an obliquely upward position.

According to the aspects of the invention, the door opening and closing structure can be provided which provides the good visibility of the interior of the accommodation space and ensures the sufficient accommodation capacity of the accommodation space.

### BRIEF DESCRIPTION OF THE DRAWINGS

FIG. 1A is a perspective view showing an instrument panel and an area surrounding the same within a passenger compartment of a vehicle, and FIG. 1B is a perspective view showing simply a door opening and closing system according to an embodiment of the invention and open and closed states thereof.

FIG. 2 is a plan view resulting when the door opening and closing apparatus according to the embodiment of the invention is seen from thereabove.

FIG. 3 is an exploded perspective view of the door opening and closing apparatus according to the embodiment of the invention is seen from thereabove.

FIG. 4 is a functional drawing showing opening and closing operations of doors of the door opening and closing apparatus according to the embodiment of the invention.

FIG. 5A is a sectional view taken along the line I-I in FIG. 2, and FIG. 5B is a sectional view taken along the line II-II in FIG. 2.

FIG. 6A is a perspective view resulting when the door opening and closing system in which the doors are in a closed position A is seen obliquely from the rear on a right-hand side thereof, and FIG. 6B is a perspective view resulting when the door opening and closing system is seen obliquely from the front on the right-hand side thereof.

FIG. 7A is a perspective view resulting when the door opening and closing system in which the doors are in an open position B is seen obliquely from the rear on the right-hand side thereof, and FIG. 7B is a perspective view resulting when the door opening and closing system is seen obliquely from the front on the right-hand side thereof.

FIG. 8A is a sectional view taken along the line III-III in FIG. 6A which illustrates a state in which a capacity of an accommodation box of the door opening and closing system according to the embodiment of the invention is expanded in an upward (height) direction, compared with a conventional structure according to the background art, and FIG. 8B is a sectional view taken along the line IV-IV in FIG. 6B which illustrates the capacity of the accommodation box of the door opening and closing system is expanded in a horizontal (width) direction, compared with the conventional structure according to the background art in which interlocking mechanisms are provided on left and right lateral sides of an accommodation box.

### DETAILED DESCRIPTION OF THE PREFERRED EMBODIMENTS

Hereinafter, an embodiment which embodies the invention will be described based on the drawings.

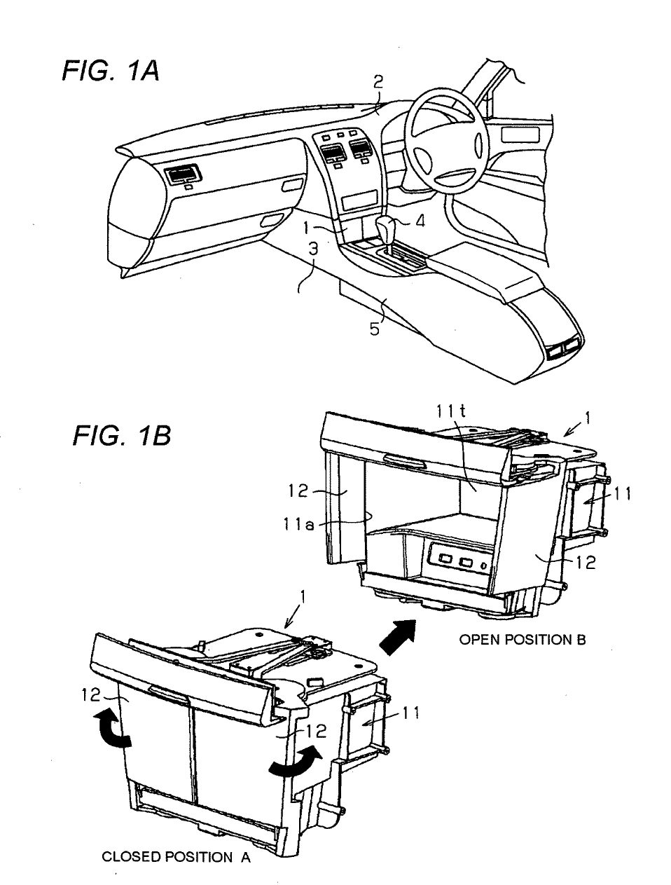

As is shown in FIG. 1A, an instrument panel 2 is provided at the front of a passenger compartment of a vehicle which is a four-wheeled motor vehicle. A center console 5, in which a shift lever 4 is disposed, is installed between a driver's seat and a front passenger's seat on a floor panel 3 within the passenger compartment to extend towards the rear (a rear seat) of the vehicle. In addition, a door opening and closing system 1 according to the invention is installed in a central portion of the instrument panel 2 which lies in front of the shift lever 4.

As is shown in FIG. 1B, this door opening and closing system 1 (door opening and closing structure) includes an accommodation box having a substantially rectangular parallelepiped configuration and a pair of left and right doors 12 which open and close at a center of a substantially horizontally elongated rectangular opening 11a which opens on to a front side of the accommodation box 11 in such a manner as a double-leafed hinged door does for opening and closure of the opening. Namely, both the doors 12 are made to be located alternately in a closed position A where the opening 11a is closed completely and an open position B where the opening 11a is opened to its full extent. A bottom portion 11t is formed on a rear side (at a bottom) of the accommodation box 11.

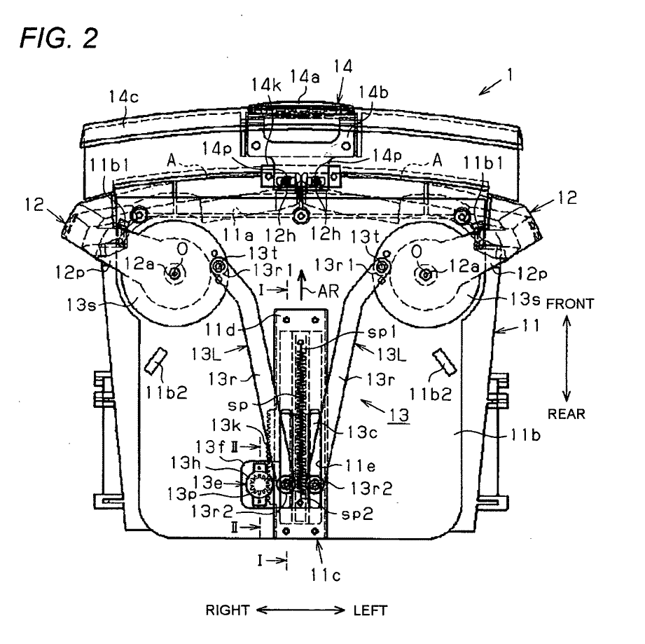

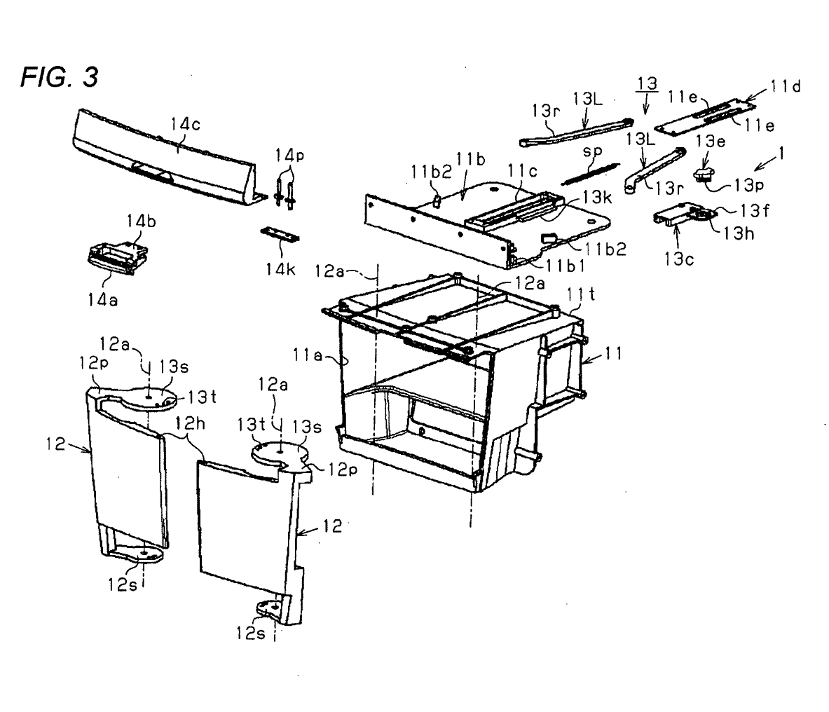

Specifically, as is shown in FIGS. 2 and 3, in the door opening and closing system 1, a pair of rotational axes 12a are set on both left- and right-hand sides of the opening 11a (refer to FIG. 1B) through which an article to be accommodated such as a pair of sunglasses is put in or out. In addition, the doors 12 are installed to rotate about the corresponding rotational axes 12a so as to open and close in such a manner as a double-leafed hinged door does for opening and closure of the opening 11a.

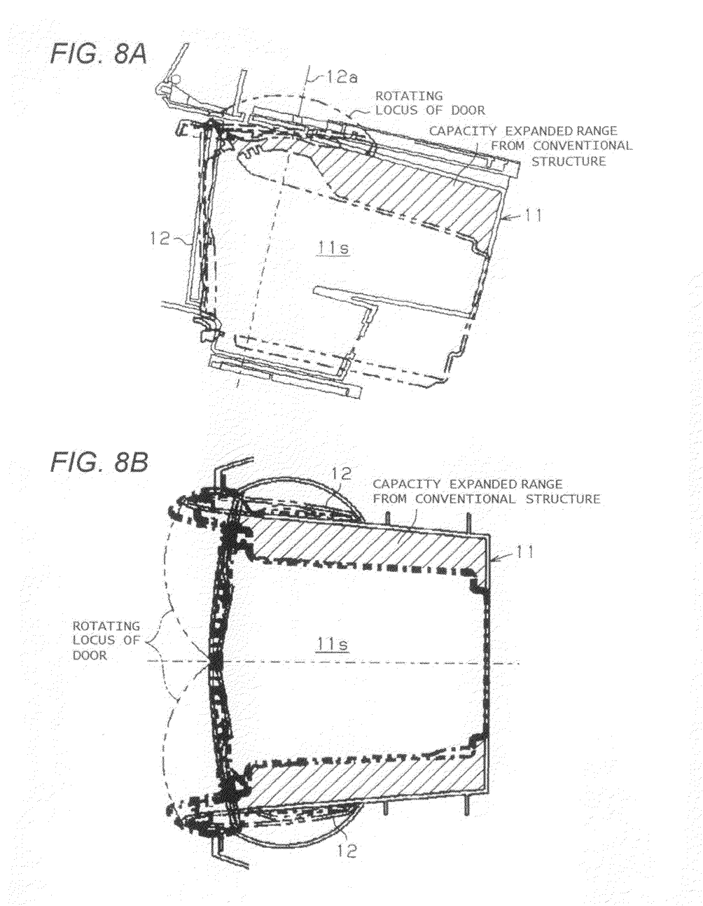

The pair of left and right rotational axes 12a are arranged to approach each other to narrow a distance therebetween as they extend downwards when the doors 12 are located in the closed position and are each set to be inclined so largely as to form a wider space between the surface of the corresponding door 12 and itself as the rotational axis extends upwards (refer to FIG. 8A) so as to constitute a configuration suitable for the structure of the central portion of the instrument panel 2 which is normally or in many cases designed to narrow its width as it extends downwards.

In addition, as is shown in FIGS. 2 and 3, the door opening and closing system 1 of the invention includes an interlocking mechanism (a non-constant velocity motion mechanism) 13 for causing both the doors 12 to open and close.

This interlocking mechanism 13 is made to convert a linear reciprocating motion in a direction which is substantially normal to a plane including the opening 11a into a rotational reciprocating motion taking place around each of the rotational axes 12a.

Specifically, this interlocking mechanism 13 includes a pair of left and right link mechanisms 13L which are provided independently on the left- and right-hand sides of the opening 11a of the accommodation box 11 to correspond individually to the rotational axes 12a.

In addition, each link mechanism 13L includes a disc-like member 13s as a crank member which is provided integrally with an upper end face portion 12p of the door 12 such that its rotational center O coincides with the rotational axis 12a, a substantially rectangular slider member 13c (refer to FIG. 3) which moves linearly in the direction which is substantially normal to the plane including the opening 11a and an arm member (a lever member) 13r which is pivotally attached to a raised portion 13t which is provided on a circumferential portion of the disc-like member 13s to be raised therefrom at a first end portion 13r₁ and is pivotally attached to the slider member 13c at a second end portion 13r₂ thereof. In addition, in the door opening and closing system shown in FIG. 3, a disc-like member 12s is provided integrally with a lower end face portion of the door 12 to be opposed to the disc-like member 13s, and the door 12 is pivotally supported on a lower surface of the accommodation box 11 at a rotational center of the disc-like member 12s to rotate round the rotational axis 12a.

Additionally, as is shown in FIGS. 2 and 3, this interlocking mechanism includes a spring member (an elastic member) sp as a biasing device for imparting a biasing force to both the doors 12 in a direction in which the opening 11a of the accommodation box 11 is opened.

This spring member sp is installed so as to impart the biasing force simultaneously to both the link mechanisms 13L in one of linear directions in which linear reciprocating motions take place.

Specifically, the spring member sp is installed to be fixedly attached to the accommodation box 11 at one end sp₁ and to the slider member 13c, to which the second end portions 13r2 of both the arm members 13r are pivotally attached, at the other end sp₂ thereof so as to generate a contracting force (an elastic force) which pulls the slider member 13c in a direction (a direction indicated by an arrow AR in FIG. 2) in which the slider member 13c is caused to approach the opening 11a of the accommodation box 11.

Specifically, as is shown in FIG. 3, an upper cover member 11b having a rectangular flat plate-like shape is fixed integrally to an upper surface of the accommodation box 11. A long guide rail portion 11c for guiding the slider member 13c slidably is formed integrally at a central portion of the upper cover member 11b to project therefrom, and the long guide rail portion 11c extends in the direction substantially normal to the plane including the opening 11a and is made to open upwards.

In addition, as is shown in FIGS. 2 to 4, a pair of left and right first raised portions 11b₁ and a pair of left and right second raised portions 11b₂ are provided in predetermined locations on the upper cover member 11b which correspond to circumferences of the rotational axes 12a to project therefrom, and these pairs of first and second raised portions 11b1, 11b2 are arranged to form a predetermined center angle (about 120 degrees in FIGS. 2 to 4) based on the corresponding rotational axes 12a.

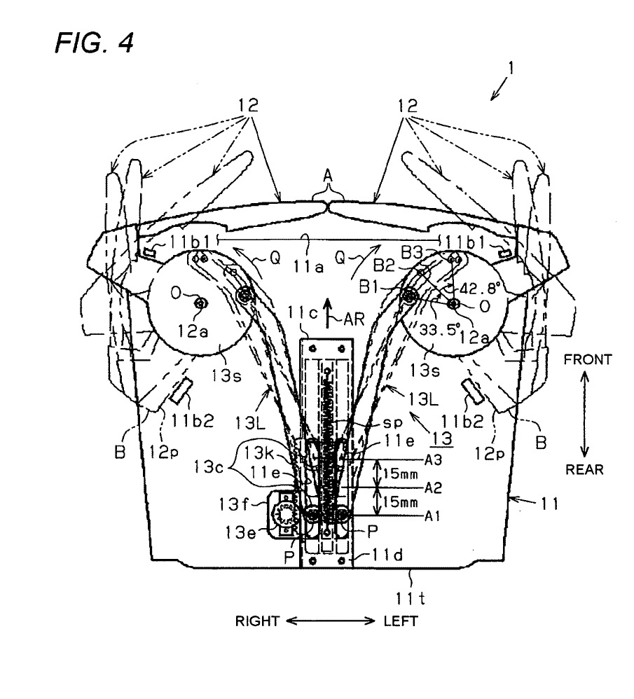

Additionally, referring to FIG. 4, each door 12 (the disc-like member 13s) is made to rotate around the corresponding rotational axis 12a in association with the slider member 13c being caused to move towards the opening 11a side (the front side) (in the direction indicated by the arrow AR) when the biasing force is imparted to the slider member 13c by the spring member sp. In addition, when rotating, each door 12 is brought into abutment with the first raised portion 11b₁ and the second raised portion 11b₂ at the upper end face portion 12p, whereby a rotational angle range (about 90 degrees) of the door 12 is restricted.

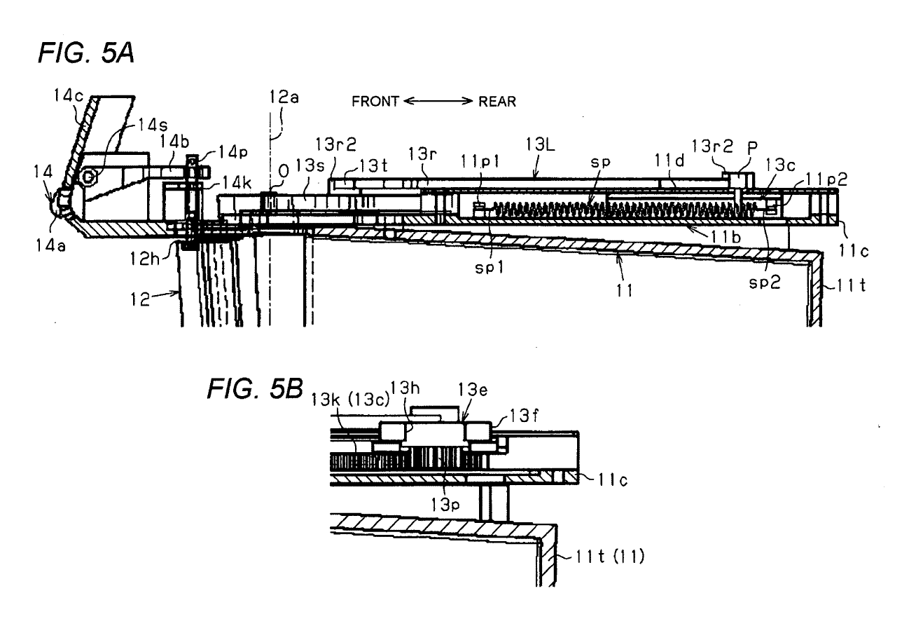

Further, as is shown in FIG. 5A, the spring member sp is locked on a first projecting portion 11p1 which is provided on the upper cover member 11b to project upwards therefrom at one end sp₁ and is locked on a second projecting portion 11p₂ which is provided at an end portion of the slider member 13c which lies to face the bottom portion 11t side (the rear side) of the accommodation box 11 to project downwards at the other end sp₂. In other words, the spring member sp is installed to extend between the first projecting portion 11pᵢ and the second projecting portion 11p₂ for extension and contraction therebetween.

Specifically, referring to FIG. 4, when both the doors 12 are in the closed position A where the opening 11a is closed completely thereby, the slider member 13c is positioned at a rear end portion of the guide rail portion 11c, and the spring member sp is in an extended state in which the spring member is extended about 30 mm from an initial length which results when no external force is applied thereto, whereby a biasing force (a contracting force) is generated so as to pull the slider member 13c in the direction indicated by the arrow AR. In addition, when both the doors 12 are released from a locked (held) state, which will be described later, the spring member sp is restored to the initial length to thereby pull the slider member 13c in the direction indicated by the arrow AR, whereby the slider member 13c is made to be displaced to a front end portion of the guide rail portion 11c and both the doors 12 are made to be displaced to the open position B via both the arm members 13r.

In addition, in the accommodation box 11 shown in FIGS. 3 and 5A, a long lid member 11d is installed between the slider member 13c and the arm members 13r to close an opening in the guide rail portion 11c so as to confine the slider member 13c within the guide rail portion 11c. Further, as is shown in FIGS. 2 to 4, a pair of elongated holes 11e are formed in the lid member 11d to extend from a longitudinal center portion to a rear end side thereof, while penetrating through the lid member 11d. Additionally, as is shown in FIG. 5A, a pair of left and right pins P are pivotally attached to second end portions 13r2 of the respective arm members 13r, and the pair of left and right pins P are fixedly inserted into the rear end portion of the slider member 13c and are loosely inserted into the elongated holes 11e individually so as to slide therein.

In addition, as is shown in FIGS. 2 to 4, 5B, a rotary damper 13e is provided in the door opening and closing system 1 (the interlocking mechanism 13) of the embodiment as a damper device for damping a liner reciprocating motion (a sliding movement) of each of the link mechanisms 13L (the slider member 13c).

Specifically, as is shown in FIGS. 2, 3 and 5B, a flat late-like projecting portion 13f is provided at the rear end portion of the slider member 13c to project in a rightward direction as viewed in FIG. 3 (to the right of FIG. 2), and the rotary damper 13e having a pinion 13p is fixedly fitted in a fitting hole 13h which is provided in the projecting portion 13f to penetrate therethrough so as not to rotate relatively. In addition, a rack 13k is formed on a right-hand lateral portion (a right-hand side as viewed in FIG. 2) of the guide rail portion 11c to project therefrom while extending in a longitudinal direction. The pinion 13p of the rotary damper 13e is made to mesh with the rack 13k. By this configuration, the slider member 13c is biased by the spring member sp, and when the slider member 13c slides to move along the guide rail portion 11c, a linear reciprocating motion (travel) of the slider member 13c is made to be damped as required.

In this embodiment, the interlocking mechanism 13 is disposed in a flat plate-like shape on the accommodation box 11 having the opening 11a.

Namely, the disc-like member 13s, the arm members 13r, the slider member 13c, the spring member sp and the rotary damper 13e, which are the constituent components of the interlocking mechanism 13, are installed in a substantially stacked state on the accommodation box 11 together with the upper cover member 11b, the guide rail portion 11c which is provided at the central portion of the upper cover member 11b and the lid member 11d, which are not constituent components of the interlocking mechanism 13. By this configuration, the overall configuration of the interlocking mechanism 13 is formed into a thin flat plate-like shape.

Further, as is shown in FIGS. 2 and 3, the door opening and closing system of the embodiment includes a lock device 14 as a lock device for holding (temporarily fixing) individually the doors 12 in the closed position A where the opening 11a in the accommodation box 11 is closed when locked and releasing the holding of the doors 12 when unlocked.

In this embodiment, the doors 12 can be fixed (locked) temporarily in the closed position A by the lock device 14 simply and in an ensured fashion.

Specifically, as is shown in FIG. 5A, the lock device 14 includes a lock button 14a which shifts inwards of the accommodation box 11 by being operated to be depressed by the driver who is an operator thereof, a lock plate 14b which is adapted to rotate downwards by being biased by an elastic member, not shown, and to rotate upwards about a pivot 14s by being brought into sliding contact with an inner end face of the lock button 14a and a pair of left and right lock pins 14p which are adapted to be locked individually in locking holes 12h which are provided on respective upper surfaces of the doors 12 to be recessed therefrom so as to hold individually the doors 12 in the locked state in the closed position A, as well as to shift upwards in association with the rotation of the lock plate 14b which is actuated by the lock button 14a being operated to be depressed by the driver so as to release the locking of the doors 12.

When the opening 11a is closed by the doors 12, the respective lock pins 14p are made to be temporarily slightly lifted up in conjunction with the rotation of the lock plate 14b and thereafter are made to slidingly fall from the rear side to the front side into the corresponding locking holes 12h in the upper surfaces of the doors 12 to thereby be locked therein, so as to lock (temporarily fix) the doors 12 individually in the closed position A.

In addition, the lock pins 14p shown in FIG. 5A are disposed at a central portion on a front side of the upper cover member 11b in such a state that the lock pins 14p are loosely inserted in a fixed plate 14k. In addition, in the door opening and closing system 1 shown in FIGS. 2, 3 and 5A, the lock button 14a is inserted into a central portion of a decorative center cover 14c which covers a front side of the upper cover member 11b and is fixed together with the center cover 14c in a predetermined location on the front side of the upper cover member 11b.

The door opening and closing system 1 of the embodiment is configured in the way described heretofore, and an operation (an opening and closing operation method) of the door opening and closing system 1 will be described specifically.

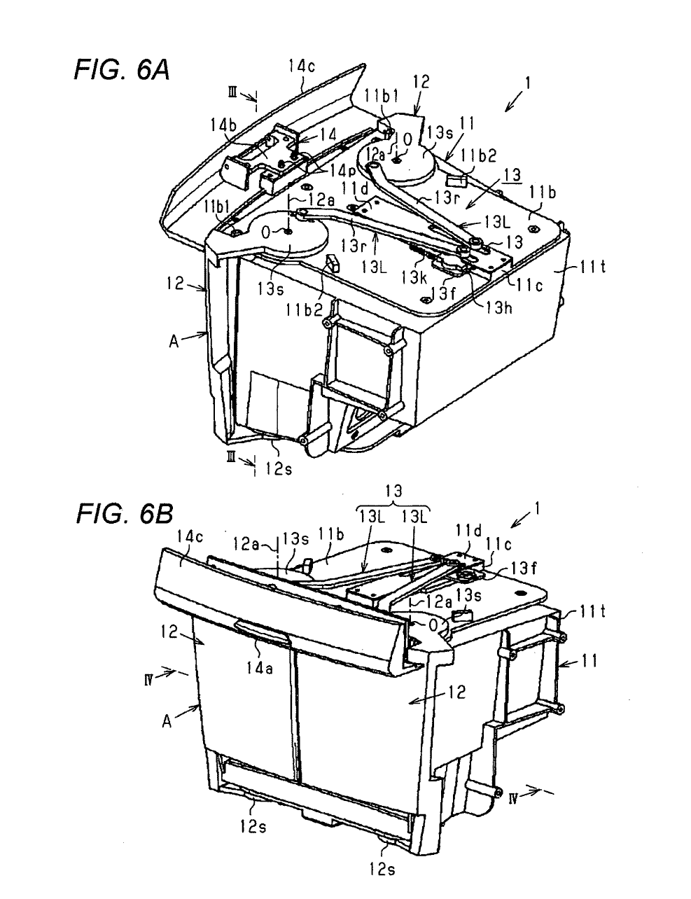

As is shown in FIGS. 6A and 6B, in the interlocking mechanism 13 (the link mechanisms 13L), when the slider member 13c and the arm members 13r are positioned so as to be closest to the bottom portion 11t (the rear side) of the accommodation box 11, the doors 12 are located in the closed position A where the opening 11a in the accommodation box 11 is closed thereby (refer to FIG. 2).

In addition, as this occurs, the spring member sp is elongated to its full extent (refer to FIG. 2), generating a biasing force which pulls the slider member 13c towards the opening 11a (the front side). Additionally, as this occurs, the doors 12 are locked in the closed position A by the lock device 14 and the upper end face portions 12p thereof are somehow brought into abutment with the first raised portions 11b₁.

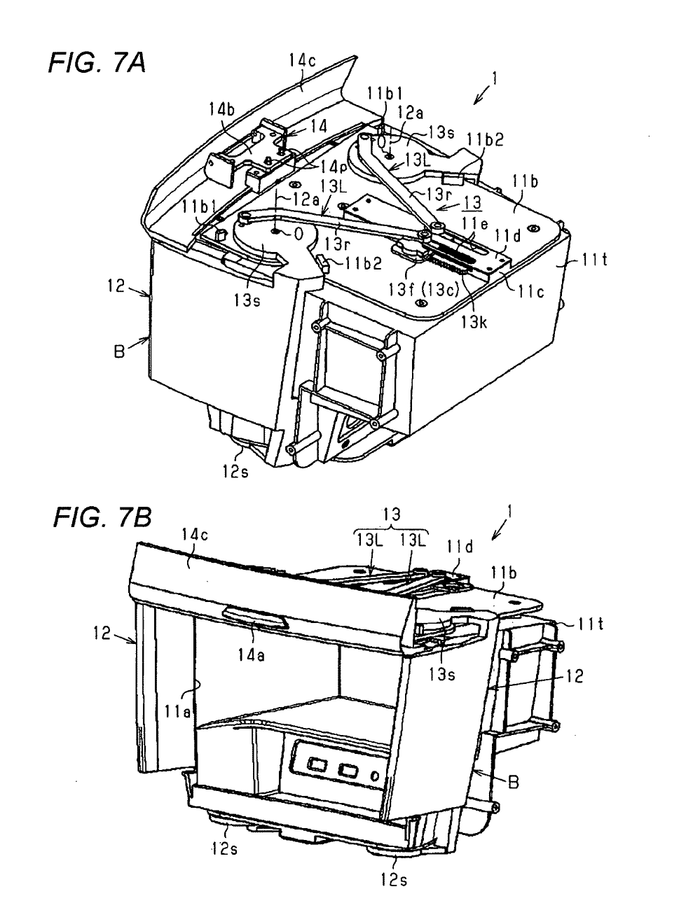

When the lock button 14a is operated to be depressed from this state, the engagement between the locking holes 12h provided on the upper surfaces of the doors 12 to be recessed therefrom and the corresponding lock pins 14p is released, whereby the doors 12 are unlocked. In association therewith, the slider member 13c which is held at the rear end portion of the guide rail portion 11c is pulled in the direction indicated by the arrow AR by virtue of the biasing force of the spring member sp, so as to be caused to move forwards (refer to FIG. 4). In addition, as the slider member 13c moves towards the front side (the opening 11a side) together with the link mechanisms 13L, an outward rotational force is imparted to the disc-like members 13s via the arm members 13r, whereby the disc-like members 13s are caused to rotate individually about 90 degrees around the corresponding rotational axes 12a in directions indicated by arrows Q (from the inside to the outside of the opening 11a), and the doors 12 are made to be displaced to the open position B while gradually opening the opening 11a, as is shown in FIGS. 7A and 7B (refer to FIG. 4). Additionally, as this occurs, the doors 12 are held in the open position B by virtue of the biasing force of the spring member sp, and the upper end face portions 12p thereof are somehow brought into abutment with the second raised portions 11b₂.

Referring to FIG. 4, in this embodiment, the doors 12 are made to open symmetrically in a mirror image-like fashion while gradually reducing their rotational angular velocities relative to the slide traveling distance of the slider member 13c together with the link mechanisms 13L. In other words, the doors 12 are made to open to gradually moderate their opening actions relative to the slide traveling of the slider member 13c. Specifically, as is shown in FIG. 4, the doors 12 rotate individually about 33.5 degrees around the corresponding rotational axes 12a from a rear rotational angle position B1 to an intermediate rotational angle position B2 while the slider member 13c (the pins P) slide travels about 15 mm from a rear end position A1 to an intermediate position A2 of the elongated holes 11e, whereas the doors 12 rotate individually about 42.8 degrees around the corresponding rotational axes 12a from the intermediate rotational angle position A2 to a front rotational angle position B3 while the slider member 13c (the pins P) slide travels about 15 mm from the intermediate position A2 to a front end position A3 of the elongated holes 11e.

In addition, as this occurs, since the linear reciprocating motion (travel) of the slider member 13c is dampened as required by the rotary damper 13e, the feeling of stable and high-quality rotating operation is allowed to be imparted to the doors.

On the other hand, when the doors 12 are caused to close, for example, in a state shown in FIGS. 7A and 7B, when one of the doors 12 is pinched with the fingers of the hand to rotate towards the inside of the opening 11a, the slider member 13c of the interlocking mechanism 13 (the link mechanisms 13L) is pressed by the door 12 via the arm member 13r to thereby be caused to slide travel to the rear side of the upper cover member 11b, while the other door 12 is caused to rotationally travel towards the inside of the opening 11a in synchronism with the one of the doors 12. Then, the doors 12 are positioned in the closed position A shown in FIGS. 6A and 6B and are then automatically locked (temporarily fixed) in the closed position A by the lock device 14.

According to the door opening and closing system and the door opening and closing structure of the embodiment, the following functions and advantages can be obtained.

(1) Since the pair of left and right doors 12 are caused to open in such a manner as a double-leafed hinged door does relative to the opening 11a of the accommodation box 11, compared with the conventional structure described under the background art, the accommodation space (capacity) 11s within the accommodation box 11 can be expanded in an upward (height) direction as is shown in FIG. 8A. By this configuration, the capacity (accommodation capacity) of the accommodation space 11s can be ensured largely in comparison with the area of the opening 11a. Further, since the interlocking mechanism 13 is disposed in the flat plate-like shape on the accommodation box 11 and the doors 12 are made to lie along the left and right lateral sides of the accommodation box so as to be stored compact when they are in the open position B, compared with the conventional structure in which the interlocking mechanisms are provided on the left and right lateral sides of the accommodation box, the accommodation space 11s within the accommodation box 11 can also be expanded in the horizontal (width) direction, as is shown in FIG. 8B. In addition, the visibility of the interior of the accommodation box 11 which results when viewed obliquely from an upper position such as the driver's line of sight position can be increased.
(2) Since the doors 12 are operated to open and close by the interlocking mechanism 13 which converts the linear reciprocating motion into the rotational reciprocating motion and the spring member sp which imparts the biasing force in the opening direction to the doors 12 via the interlocking mechanism 13, an automatic opening and closing operation of the doors 12 can be realized by the structure which is inexpensive and is easy to be adjusted without a motor as a driving source and a complex speed reduction mechanism required.
(3) In converting the linear reciprocating motion (slide travel) of the slider member 13c into the rotational reciprocating motion (rotation) of the doors 12 (the disc-like members 13s), the interlocking mechanism 13 can make the doors 12 operate such that the rotational angular velocities of the doors 12 gradually decrease relative to the liner traveling distance (traveling speed) of the slider member 13c. By this, the doors 12 are caused to rotate quickly when they start to open, and thereafter, the doors 12 are made to close with their rotational speeds gradually moderated, whereby a change with the feeling of high-quality and stability can be brought up in the rotating operation of each of the doors 12.
(4) Since the interlocking mechanism 13 which converts the linear reciprocating motion into the rotational reciprocating motion is made up of the pair of link mechanisms 13L and the biasing force of the spring member sp is applied in the direction in which the link mechanisms 13L moves linearly (the slide travel direction), as the spring member sp, the means can be adopted which has the simple structure in which only the function is provided to bias the link mechanisms 13L in the linear direction. In addition, since the link mechanisms 13L are provided left and right independently to correspond individually to the rotational axes 12a and the spring member sp is made to impart the biasing force simultaneously to the link mechanisms 13L in the linear direction of the linear reciprocating motions which is oriented towards the opening 11a, the synchronized rotational reciprocating operations of the doors 12 can be realized by the link mechanisms 13L while allowing for easy adjustment and ensured operation.
(5) Mounting of both the doors 12 for synchronized opening and closing of the doors 12 and setting of such synchronized opening and closing conditions of both the doors 12 can be implemented simply and in an ensured fashion by the pair of left and right link mechanisms 13L each including the disc-like member 13s as the crank member 13 which is provided integrally with the door 12 so that its rotational center coincides with the corresponding rotational axis 12a, the slider member 13c which is adapted to move linearly in the direction which is substantially normal to the plane including the opening 11a, and the arm member 13r which is pivotally attached to the disc-like member 13s at the first end portion and is pivotally attached to the slider member 13c at the second end portion thereof without plays and looseness (backlash) between gears which would be generated should a gear meshing mechanism be used.
(6) Since the interlocking mechanism 13 is installed in the flat plate-like shape on the accommodation box 11, compared with the conventional structure described under the background art, the accommodation space of the accommodation box 11 can be expanded further in the upward direction (refer to FIG. 8A).
(7) Since each of the rotational axes 12a is set to be inclined so largely as to form the wider space between the surface of the corresponding door 12 and itself as the rotational axis 12a extends upwards, when having arrived at the open position B, the doors 12 lie to narrow a distance therebetween as they extend downwards (refer to FIG. 7B). Because of this, when having arrived the open position B, both the doors 12 are disposed to lie along the left and right lateral sides of the accommodation space to gradually narrow their width or the distance therebetween as they extend downwards, which provides a configuration suited to a design required for the central portion of the instrument panel. In addition, by this configuration, advantages are provided effectively that the accommodation space is expanded and that the visibility of the interior of the accommodation space is increased which results when the interior of the accommodation space is observed from an obliquely upward position.

Note that the embodiment may be modified as follows.
In the embodiment, the link mechanisms 13L are adopted in the interlocking mechanism 13 which converts the linear reciprocating motion (slide travel) into the rotational reciprocating motion (rotation). However, the invention is not limited thereto. For example, a cam mechanism can also be adopted.
In the embodiment, the door opening and closing structure according to the technical idea of the invention is applied to the door opening and closing system 1 which is installed in the central portion of the instrument panel 2 of the vehicle such that the opening 11a of the accommodation box 11 is oriented towards the rear of the vehicle and in which the doors 12 are caused to open in such a way as a double-leafed hinged door does relative to the opening 11a. However, the application of the door opening and closing structure is not limited thereto. For example, the door opening and closing structure can be applied to a door opening and closing system which is installed in the center console of the vehicle such that the opening 11a of the accommodation box 11 extends in the length (front-rear) direction and is oriented substantially upwards and in which the doors 12 are made to open in such a manner as a double-leafed hinged door does relative to the opening 11a.
In the embodiment, the spring member sp, which is the biasing device, is installed in the pair of left and right link mechanisms 13L which are provided at the opening 11a of the accommodation box 11 to impart the biasing force to the linear reciprocating motion of the slider member 13c. However, the invention is not limited thereto, and hence, the spring member sp can be installed to impart the biasing force to the rotational reciprocating motion of the disc-like members 13s.
In the embodiment, the spring member sp, which is the biasing device, is installed in the pair of left and right link mechanisms 13L which are provided at the opening 11a of the accommodation box 11 to impart the biasing force which is directed forwards (to approach the opening 11a of the accommodation box 11) to the linear reciprocating motion of the slider member 13c. However, the invention is not limited thereto, and hence, the spring member sp can be installed to impart the biasing force which is directed oppositely to the direction above, that is, rearwards (to move away from the opening 11a of the accommodation box 11) to the linear reciprocating motion of the slider member 13c. As this occurs, the doors 12 are made to be biased in directions in which they close the opening 11a. Namely, the doors 12 can be made to be locked in the open position B and to be unlocked to automatically perform the closing operation to be held in the closed position A.
In the embodiment, the lock device 14, which is the lock device, is made to hold the doors 12 in the closed position A where the opening 11a is closed completely when locked and to release the holding of the doors 12 when unlocked by the lock button 14a being operated to be depressed. However, the invention is not limited thereto, and hence, the lock device 14 can be made to locked when the doors 12 are in the open position B where the opening 11a is opened completely and to be unlocked so as to make the doors automatically perform the closing operation to be located in the closed position A where the opening 11a is closed completely.

What is claimed is:

1. A door opening and closing structure having a pair of rotational axes set on left and right sides of an opening through which an article is put in or out and a pair of left and right doors which are capable of rotating individually on the rotational axes so as to open and close, wherein
the doors opens and closes via an interlocking mechanism for converting a linear reciprocating motion which is substantially normal to a plane including the opening into a rotational reciprocating motion on each of the rotational axes and are stored to lie individually along left and right lateral sides of an accommodation space having the opening when the doors are in open positions where the opening is opened to a full extent.

2. A door opening and closing structure as set forth in claim 1, wherein
the interlocking mechanism includes a biasing device for imparting a biasing force to the doors in a direction in which the opening is opened or closed.

3. A door opening and closing structure as set forth in claim 2, wherein
the interlocking mechanism comprises a pair of link mechanisms which are provided independently on the left and right sides of the opening to correspond to the rotational axes individually, and the biasing device is made to impart a biasing force simultaneously to the link mechanisms in one of linear directions in which linear reciprocating motions take place.

4. A door opening and closing structure as set forth in claim 3, wherein
the link mechanisms each comprise a crank member which is provided integrally with the door such that a rotational center thereof coincides with the rotational axis of the door, a slider member adapted to move linearly in a direction which is substantially normal to the plane including the opening, and an arm member which is pivotally attached to the crank member at a first end portion and is pivotally attached to the slider member at a second end portion thereof, and wherein
the biasing device is an elastic member which is installed to be fixed to the accommodation box having the opening at one end and to be fixed to the slider member at the other end thereof so as to generate a biasing force which biases the slider member in a direction in which the slider member moves towards or away from the opening.

5. A door opening and closing structure as set forth in claim 1, comprising:
a damper device for damping a linear reciprocating motion of the interlocking mechanism.

6. A door opening and closing structure as set forth in claim 1, comprising further:
a lock device for holding the doors in a closed position where the opening is closed completely or the open position where the opening is opened to the full extent when locked and releasing the holding of the doors when unlocked.

7. A door opening and closing structure as set forth in claim 1, wherein
the interlocking mechanism is disposed in a flat plate-like shape on the accommodation box having the opening.

8. A door opening and closing system comprising the door opening and closing structure set forth in claim 1 and adapted to be installed in a central portion of an instrument panel of a vehicle, wherein
each of the rotational axes is set to be inclined so largely as to form a wider space between a surface of the corresponding door and said rotational axis as said rotational axis extends upwards.
